(19) United States
(12) Patent Application Publication
(10) Pub. No.: US 2005/0021194 A1
(43) Pub. Date: Jan. 27, 2005

(54) Bicycle treadle

(76) Inventor: Wen-Hwa Lin Chu, Tai Chung Hsien (TW)

Correspondence Address: WEN-HWA LIN CHU, 235 Chung-Ho, Box 8-24, Taipei, TW

(21) Appl. No.: 10/626,889

(22) Filed: Jul. 25, 2003

(51) Int. Cl. G05D 1/00

(52) U.S. Cl. 701/22

(57) ABSTRACT

A bicycle treadle which comprises a treadle body, a front hook locking to a locking surface of the treadle body; a rear hook locking to a rear side of the treadle body; and an elastomer resisting against the rear hook. A front end of the front hook is formed with a buckle, the buckle having a hole. Each of two sides of the buckle contacting with the front hook has a tilt surface. A buckling sheet is buckled to the buckle of the front hook. Two rear sides of the front hook have respective wings. Each wing is protruded from a surface of the front hook. Two sides of the rear hook have respective limiting stops corresponding to the wings. In assembly, the two limiting stops resist against the two wings.

### FIELD OF THE INVENTION

The present invention relates to bicycle treadles, and particularly to a bicycle treadle which can be assembled and positioned easily.

### BACKGROUND OF THE INVENTION

In a competition-used bicycle, a buckling sheet is used to position a shoe to the treadle of the bicycle, as shown in FIG. 1. The treadle is mainly formed by a treadle body, a main buckle and a sub-buckle and an elastomer. The main buckle is buckled to the front surface of the treadle body. A front end of the main buckle is protruded with a close buckle portion and two resisting portions with bent upwards so as to be vertical to the main buckle. A rear end thereof has a limiting protrusion and two positioning protrusions at two sides. The sub-buckle is pivotally installed to a rear end of the treadle body. The sub-buckle has a limiting protrusion at a rear end thereof and positioning protrusions at two sides. Furthermore, the sub-buckle is pivotally installed to the rear side of the treadle body and a stop is protruded from the sub-buckle (not shown). The stop is parallel to the buckle for buckling the buckling sheet. The elastomer is installed between the sub-buckle and the treadle body. In assembling the prior art treadle body, a gap is installed between the main buckle and the sub-buckle for buckling the buckling sheet. The limiting protrusion at the rear end of the main buckle resists against the inner wall of the sub-buckle will determine the size of the gap (referring to FIG. 2). Since the limiting protrusion only protrudes from a middle section of the main buckle, and must precisely contact the inner wall of the sub-buckle, the errors in assembly and positioning are large and assembly and positioning works are tedious.

Furthermore, the positioning portions at two front sides of the main buckle stop transversally the path for buckling the main buckle. The user only buckles the buckles at a specific direction so that the front end of the buckling sheet can enter into the buckling portion of the main portion. However, this will make some inconvenience in assembly. Moreover, in a competition process, if the buckling sheet separates from the buckle carelessly, it is difficult to re-buckle the buckling sheet to the buckle in emergency. Thus, ability of the competitor is affected.

### SUMMARY OF THE INVENTION

Accordingly, the primary object of the present invention is to provide a bicycle treadle which comprises a treadle body, a front hook locking to a locking surface of the treadle body; a rear hook locking to a rear side of the treadle body; and an elastomer resisting against the rear hook. A front end of the front hook is formed with a buckle; the buckle having a hole. Each of two sides of the buckle contacting with the front hook has a tilt surface. A buckling sheet is buckled to the buckle of the front hook. Two rear sides of the front hook has respective wings. Each wing is protruded from a surface of the front hook. Two sides of the rear hook have respective limiting stops corresponding to the wings. In assembly, the two limiting stops resist against the two wings. In use, a buckling sheet in a sole of a shoe is buckled with the buckle so that the shoe is fixed therein.

The various objects and advantages of the present invention will be more readily understood from the following detailed description when read in conjunction with the appended drawing.

### BRIEF DESCRIPTION OF THE DRAWINGS

FIG. 1 is a schematic perspective view of the prior art treadle.

FIG. 2 is an assembly view of the prior art treadle.

FIG. 3 is a schematic perspective view of the present invention.

FIG. 4 is an exploded schematic view of the present invention.

FIG. 5 is an assembled view of the present invention.

FIG. 6 is an assembly schematic view of the second embodiment of the present invention.

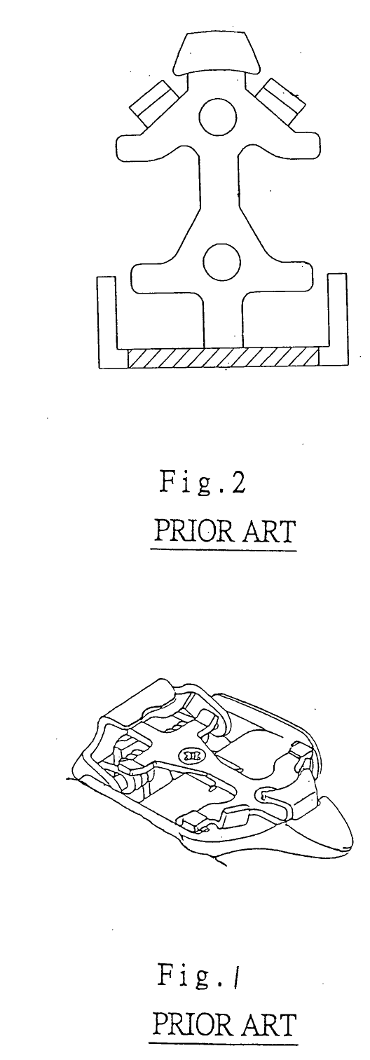

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

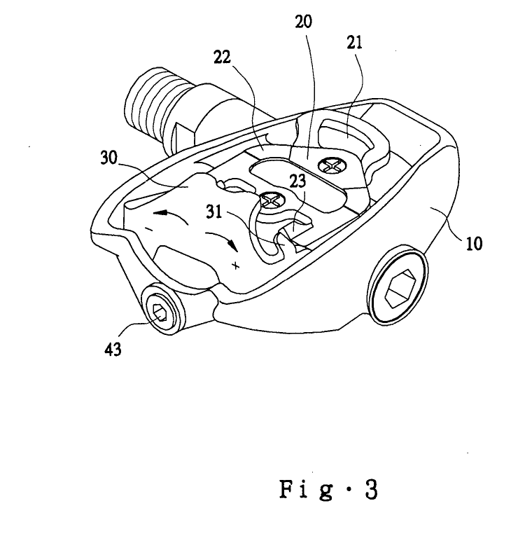

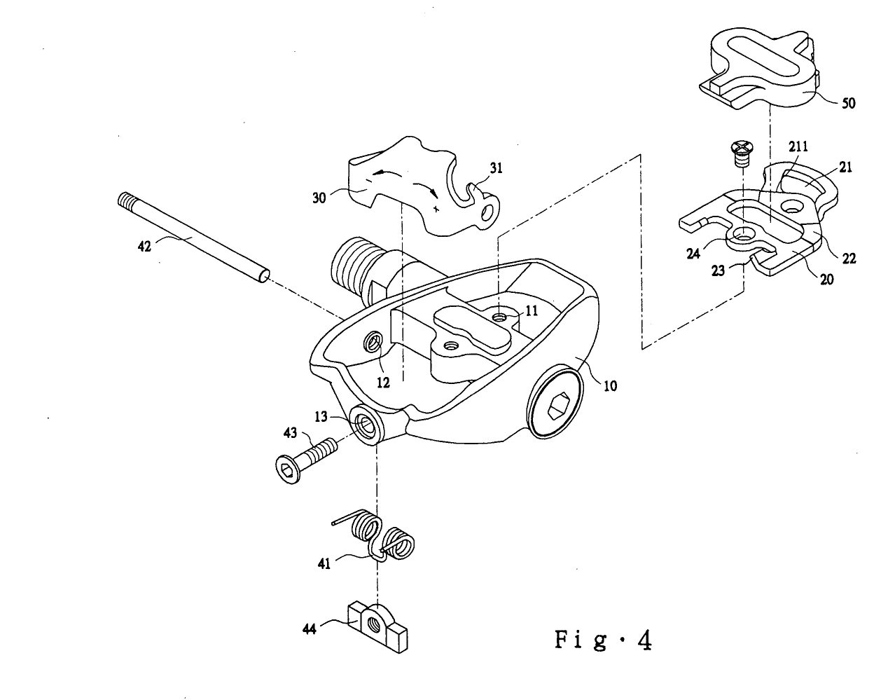

Referring to FIGS. 3 and 4, the bicycle treadle of the present invention is illustrated. The bicycle treadle includes a treadle body 10, a front hook 20, a rear hook 30, an elastomer 41, a stud 42, etc.

A screw hole 11 is formed on a surface of the treadle body 10 for locking the front hook 20. A lateral screw hole 12 is formed at one lateral surface of the screw hole 11. A stud 42 passes through the rear hook 30 and the elastomer 41 for locking the rear hook 30 and the elastomer 41. A rear end of the treadle body 10 has a locking hole 13. A positioning screw 43 passes through the locking hole 13 and a hole in a positioning block 44 so as to fix the positioning block 44.

The front hook 20 has a “Z” shape. The front hook 20 is formed with two through holes 24. Thereby, screws can pass through the two through hole 24 to lock the front hook 20 to the treadle body 10. A front end of the front hook 20 is formed with a buckle 21. Each of two sides of the buckle 21 contacting with the front hook 20 has a tilt surface 211. Moreover, two front lateral sides of the front hook 20 have respective protruding portions 22. A buckling sheet 50 is buckled to the buckle 21 of the front hook 20. Two rear sides of the front hook 20 have respective wings 23. Each wing 23 is protruded from a surface of the front hook 20.

A stud 42 passes through the rear hook 30 to be locked to a rear side of the treadle body 10. The rear hook 30 resists against the elastomer 41. Two sides of the rear hook 30 have respective limiting stops 31 corresponding to the wings 23. In assembly the rear hook 30, the two limiting stops 31 resist against the two wings 23.

Thereby, by above mentioned components, in assembling the treadle, the wings 23 of the front hook 20 resist against the limiting stops 31 of the rear hook 30 so that the assembly work is simplified. Furthermore, the arrangement of the front hook 20 and the rear hook 30 can be handled precisely. By the two protruding portions 22, the buckling sheet 50 is easily buckled to the front hook 20.

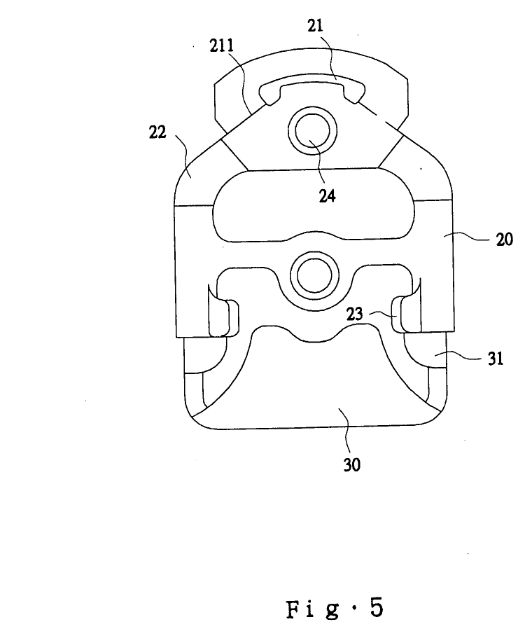

With reference to FIG. 5, the front hook 20 is firstly locked to the treadle body 10, the rear hook 30 is then installed to the rear end of the treadle body 10. The limiting stops 31 can be precisely in contact with the wings 23 of the front hook 20. Thereby, the gap of the front hook 20 and rear hook 30 for buckling the buckling sheet 50 can be precisely controlled so as to improve the quality of the product and the assembly efficiency.

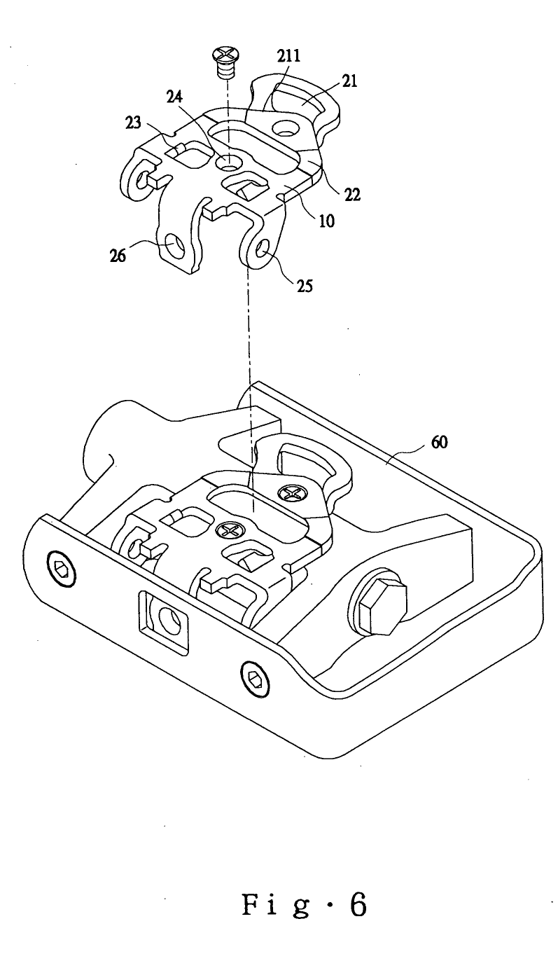

With reference to FIG. 6, the second embodiment of the present invention is illustrated. The front hook 20 has an approximate N shape. Two through holes 24 are formed on the front hook 20. A front top of the front hook 20 has a buckle 21. Two sides of the buckle 21 contacting the front hook 20 have respective tilt surfaces 211. Moreover, two front lateral sides of the front hook 20 have respective protruding portions 22. Two sides of the rear hook 30 have respective limiting stops 31 corresponding to the wings 23. Each of the two rear lateral sides of the rear hook 30 has a lateral locking hole 25. A rear locking hole 26 is formed between the two lateral locking holes 25 so that the rear hook 30 can be locked to various treadle body 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A bicycle treadle comprising a treadle body, a front hook locking to a locking surface of the treadle body; a rear hook locking to a rear side of the treadle body; and an elastomer resisting against the rear hook;
a front end of the front hook being formed with a buckle; the buckle having a hole; each of two sides of the buckle contacting with the front hook having a tilt surface; a buckling sheet being buckled to the buckle of the front hook; two rear sides of the front hook having respective wings; each wing being protruded from a surface of the front hook; two sides of the rear hook having respective limiting stops corresponding to the wings; in assembly, the two limiting stops resisting against the two wings;
wherein in use, a buckling sheet in a sole of a shoe is buckled with the buckle so that the shoe is fixed therein.

2. The bicycle treadle as claimed in claim 1, wherein two front lateral sides of the front hook have respective protruding portions for facilitating the assembly of the buckling sheet to the buckle.

3. The bicycle treadle as claimed in claim 1, wherein each of the two rear lateral sides of the rear hook has a lateral locking hole; a rear locking hole is formed between the two lateral locking holes so that the rear hook is locked to various treadle body.
